(19) United States
(12) Patent Application Publication
(10) Pub. No.: US 2026/0319467 A1
(43) Pub. Date: Oct. 15, 2026

(54) MULTI-BEAM LASER-BASED WELD SEAM RECOGNITION AND WELDING PATH PLANNING METHOD ORIENTED TO THE WELDING AND PACKAGING OF CYLINDER AND COVER PLATE

(71) Applicant: SOUTHEAST UNIVERSITY, Nanjing (CN)

(72) Inventors: Yongzhe LI, Nanjing (CN); Yexing ZHENG, Nanjing (CN); Xiaochao LIU, Nanjing (CN); Yijun ZHOU, Nanjing (CN); Xiaoyu WANG, Nanjing (CN)

(73) Assignee: SOUTHEAST UNIVERSITY, Nanjing (CN)

(21) Appl. No.: 19/688,550

(22) Filed: May 27, 2026

Related U.S. Application Data
(63) Continuation of application No. PCT/CN2025/127609, filed on Oct. 14, 2025.

(30) Foreign Application Priority Data
Nov. 22, 2024 (CN) 202411680425.1

(51) Int. Cl. G05B 19/4155; B23K 26/28; B23K 101/06; G06T 7/00; G06T 7/246; G06T 7/62; G06T 7/73; G06V 20/50

(52) U.S. Cl. CPC G05B 19/4155; B23K 26/28; G06T 7/001; G06T 7/248; G06T 7/62; G06T 7/74; G06V 20/50; B23K 2101/06; G05B 2219/45138; G06T 2207/30136; G06T 2207/30241

(57) ABSTRACT

A multi-beam laser-based weld seam recognition and welding path planning method oriented to the welding and packaging of a cylinder and a cover plate includes the following steps: Projecting n parallel linear laser fringes onto the surfaces of a cylinder and a cover plate to be welded simultaneously, where n≥2; capturing and acquiring all the linear laser fringe images. Identifying the inflection point coordinates of all linear laser fringes, and fitting the outer circle of the cover plate and the inner circle of the outer cylinder. Calculating the inner wall circle of the cylinder; taking the central ellipse of the figure between the inner wall circle of the cylinder and the outer circle of the cover plate as the welding trajectory. Taking the widest part of the overlapping region where the cover plate and the cylinder wall are lapped and coincided as the starting point of the welding trajectory.

### CROSS REFERENCE TO THE RELATED APPLICATIONS

This application is a continuation application of International Application No. PCT/CN2025/127609, filed on Oct. 14, 2025, which is based upon and claims priority to Chinese Patent Application No. 202411680425.1, filed on Nov. 22, 2024, the entire contents of which are incorporated herein by reference.

### TECHNICAL FIELD

The patent relates to the technical field of welding automation, and in particular, to a multi-beam laser-based weld seam recognition and welding path planning method oriented to the welding and packaging of a cylinder and a cover plate.

### BACKGROUND

In industries such as shipbuilding, chemical engineering, and military equipment manufacturing, cylindrical structures are widely used in various pressure vessels and reaction vessels. In recent years, with the increasing demand for lightweight development of various industrial vessels, the demand for small-sized cylindrical structural components or thin-walled cylindrical structural components has been growing steadily. Cylindrical vessels usually have high requirements for strength and sealing performance.

The packaging and welding of cover plates for small-sized or thin-walled cylinders are typically characterized by tiny weld seams and high requirements for welding precision. The joints for this type of welding are mostly in the form of bottom-locked butt joints, that is, a recess of a certain width is formed on the inner wall of the cylinder at the end thereof to create a step, and the cover plate is installed in the step to complete the welding and packaging.

However, due to the inability to ensure the coincidence of the central axes of the cylinder and the cover plate when clamping the cylinder wall and the cover plate before welding, a positional deviation occurs between the cover plate and the cylinder, which further causes an offset between the overlapping area of the cover plate and the edge of the cylinder wall and the preset welding trajectory. Since the lap joint is located under the cover plate and blocked by the cover plate, this offset cannot be directly observed.

For the welding of ultra-thin-walled cylinders, in order to reduce the thermal influence of welding, a welding heat source with short-duration, high power, and high concentration is mainly used to heat the metal to be welded. The offset between the area to be welded and the preset welding trajectory will have a serious impact on the welding of the thin-walled cylinder cover plate, making it unable to meet the requirements for strength and sealing performance, and even leading to welding defects and failure of the overall welded structure. Therefore, the welding trajectory should be aligned with the center of the overlapping area between the cylinder wall and the cover plate.

In addition, the high heat input during the welding process will cause thermal deformation of the cover plate. The start point and end point of such arc-shaped weld seams are at the same position, which are repeatedly heated during welding, easily causing deformation and affecting the overall structure of the component. If the welding start point is set at the position where the overlapping width between the cover plate and the cylinder wall is narrow, repeated heating of this position will make thermal deformation more likely to occur. Therefore, it is necessary to plan the start point of the welding trajectory.

At the current stage, the method of single-line laser scanning is mainly used for weld seam recognition. However, for the packaging and welding of cover plates for small-sized or thin-walled cylinders, the welding area is small; the use of continuous scanning with a single-line laser is time-consuming and labor-intensive, and has low precision, which will significantly reduce production efficiency.

### SUMMARY

Technical solution: The multi-beam laser-based weld seam recognition and welding path planning method oriented to the welding and packaging of a cylinder and a cover plate includes the following steps:
Simultaneously projecting n parallel linear laser fringes onto the surfaces of a cylinder and a cover plate to be welded, where n≥2, and capturing and acquiring all images of the linear laser fringes;
Identifying the coordinates of inflection points of all linear laser fringes in the acquired images, and fitting the outer circle of the cover plate and the inner circle of the outer cylinder according to the identified coordinates of the inflection points;
Calculating the inner wall circle of the cylinder based on the inner circle of the outer cylinder and the wall thickness of the cylinder, and taking the ellipse between the inner wall circle of the cylinder and the outer circle of the cover plate as the welding trajectory;
Taking the widest part of the overlapping region where the cover plate and the cylinder wall are lapped and coincided as the start and end points of the welding trajectory.

Further, the parallel linear laser fringes are generated by a linear laser device; the images of the linear laser fringes are captured by a camera arranged at a preset angle relative to the laser projection direction; and the geometric features of the linear laser fringes are reconstructed according to the principle of triangulation.

Further, the inflection points include outer inflection points and inner inflection points. The outer inflection points are the intersection points of the linear laser fringes with the adjacent surfaces of a boss of the cylinder and the gap between the cylinder and the cover plate; the inner inflection points are the intersection points of the linear laser fringes with the adjacent surfaces of the cover plate and the gap; and the total number of the inflection points is 4*n.

Still further, the equation of the inner circle C₀ of the outer cylinder is fitted according to 2*n outer inflection points:

$${( {x}_{1} - {x}_{o} )}^{2} + {( {y}_{1} - {y}_{o} )}^{2} = {R}_{o}^{2}$$

where xₒ and yₒ are the coordinates of the center of the inner circle of the outer cylinder, Rₒ is the radius of the inner circle of the outer cylinder, and x₁ and y₁ are the horizontal and vertical coordinates of points on the inner circle of the outer cylinder;
The equation of the outer circle Cᵣ of the cover plate is fitted according to 2*n inner inflection points:

$${( {x}_{2} - {x}_{r} )}^{2} + {( {y}_{2} - {y}_{r} )}^{2} = {R}_{r}^{2}$$

where xᵣ and yᵣ are the coordinates of the center of the outer circle of the cover plate, Rᵣ is the radius of the outer circle of the cover plate, and x₂ and y₂ are the horizontal and vertical coordinates of points on the outer circle of the cover plate.

Further, the equation of the inner wall circle of the cylinder is described as:

(x₃−x₀)²+(y₃−y₀)²=(Rₒ−t)²
where x₀ and y₀ are the coordinates of the center of the inner circle of the outer cylinder, x₃ and y₃ are the horizontal and vertical coordinates of points on the inner wall circle of the cylinder, Rₒ is the radius of the inner circle of the outer cylinder, and t is obtained by subtracting the thickness of the cylindrical boss from the total wall thickness of the cylinder.

Further, the method for calculating the welding trajectory is as follows:

First, connect the center Oᵢ of the inner wall circle of the cylinder and the center Oᵣ of the outer circle of the cover plate, calculate the 4 intersection points of the straight line where OᵢOᵣ lies with the outer circle of the cover plate and the inner wall circle of the cylinder, and denote them in sequence as A₁, B₁, A₂ and B₂; take the midpoint C₁ of A₁ and B₁ and the midpoint C₂ of A₂ and B₂ as the endpoints of the major axis of the ellipse; draw a perpendicular line to OᵢOᵣ through the midpoint of the centers Oᵢ and Oᵣ of the two circles, with the intersection points with the two circles denoted in sequence as A₃, B₃, A₄ and B₄; take the midpoint C₃ of A₃ and B₃ and the midpoint C₄ of A₄ and B₄ as the endpoints of the minor axis of the ellipse; calculate the ellipse based on C₁, C₂ C₃, and C₄, i.e., the central ellipse of the figure between the inner wall circle of the cylinder and the outer circle of the cover plate, which serves as the welding trajectory.

Still further, if |A₁B₁|>|A₂B₂|, the start and end points of the welding trajectory are C₁; otherwise, the start and end points of the welding trajectory are C₂.

The system corresponding to the method includes:
a laser fringe image acquisition unit, configured to simultaneously project n parallel linear laser fringes onto the surfaces of a cylinder and a cover plate to be welded (where n≥2), and capture and acquire all images of the linear laser fringes;
a fitting unit, configured to identify the coordinates of inflection points of all linear laser fringes in the acquired images, and fit the outer circle of the cover plate and the inner circle of the outer cylinder according to the identified coordinates of the inflection points;
a welding trajectory calculation unit, configured to calculate the inner wall circle of the cylinder based on the inner circle of the outer cylinder and the wall thickness of the cylinder, and take the central ellipse of the figure between the inner wall circle of the cylinder and the outer circle of the cover plate as the welding trajectory;
a welding trajectory start or end point determination unit, configured to take the widest part of the overlapping region where the cover plate and the cylinder wall are lapped and coincided as the start and end points of the welding trajectory.

An electronic device for storing and executing the method includes:
a memory storing executable program codes;
a processor coupled to the memory;
wherein the processor invokes the executable program codes stored in the memory and executes the steps of the aforementioned method for multi-beam laser-based weld seam recognition and welding path planning method oriented to the welding and packaging of a cylinder and a cover plate.

A computer-readable storage medium for storing and executing the aforesaid method, characterized in that the computer-readable storage medium stores computer instructions, and when the computer instructions are invoked, they are used to execute the steps of the weld seam recognition and welding path planning method for multi-beam laser welding oriented to the welding and packaging of cylindrical cover plates.

Compared with the prior art, the present invention has the following significant technical effects: It takes into account the positional deviation caused by the non-coincidence of the central axes of the cylinder and the cover plate, and overcomes the problem that the lap joint is covered by the cover plate, making it impossible to directly observe the axial misalignment deviation. It conducts reasonable planning on the welding start and end points, which can reduce the occurrence of welding defects. It only needs to capture a single image to realize weld seam recognition and welding path planning, which significantly improves production efficiency. It is particularly suitable for the welding of thin-walled cylindrical cover plates or micro-miniature cylindrical cover plates that have high requirements for welding precision.

### BRIEF DESCRIPTION OF THE DRAWINGS

FIG. 1 is a schematic flow of the method according to the present invention;

FIG. 2 is a schematic diagram of a multi-beam laser-based weld seam recognition system oriented to the welding and packaging of a cylinder and a cover plate provided in an embodiment of the present invention;

FIG. 3 is a schematic diagram of a multi-beam linear laser sensor provided in an embodiment of the present invention.

FIG. 4 is a schematic diagram of a workpiece to be welded (including a cylinder and a cover plate) provided in an embodiment of the present invention;

FIG. 5 is a schematic diagram of an image acquired by the multi-beam laser-based weld seam recognition and welding path planning method oriented to the welding and packaging of a cylinder and a cover plate provided in an embodiment of the present invention;

FIG. 6 is a schematic diagram of fitting the inner circle of the outer cylinder and the outer circle of the cover plate in the multi-beam laser-based weld seam recognition and welding path planning method oriented to the welding and packaging of a cylinder a cover plate provided in an embodiment of the present invention;

FIG. 7 is a schematic diagram of the geometric features of the end of the cylinder and the cover plate to be welded in the multi-beam laser-based weld seam recognition and welding path planning method oriented to the welding and packaging of a cylinder a cover plate provided provided in an embodiment of the present invention;

FIG. 8 is a schematic diagram of welding trajectory calculation in the multi-beam laser-based weld seam recognition and welding path planning method oriented to the welding and packaging of a cylinder a cover plate provided in an embodiment of the present invention;

FIG. 9 is a schematic diagram of the welding process of the cylindrical cover plate provided in an embodiment of the present invention.

FIG. 10 is a real cylinder and a real cover plate of a specific implementation case provided in an embodiment of the present invention.

FIG. 11 is a multi-beam laser image captured in a specific implementation case provided in an embodiment of the present invention.

### DETAILED DESCRIPTION OF THE EMBODIMENTS

To make the objectives, technical solutions and advantages of the present invention clearer, the technical solutions in the embodiments of the present invention will be clearly and completely described below in conjunction with the accompanying drawings in the embodiments of the present invention. Apparently, the described embodiments are part of the embodiments of the present invention, rather than all the embodiments.

Therefore, the following detailed description of the embodiments of the present invention provided in the accompanying drawings is not intended to limit the scope of the claimed present invention, but merely represents selected embodiments of the present invention. Based on the embodiments in the present invention, all other embodiments obtained by those of ordinary skill in the art without making creative efforts shall fall within the protection scope of the present invention.

The present invention adopts a multi-beam laser-based detection method to recognize the weld seam between the cylinder and the cover plate to be welded, and plan the welding trajectory. It only needs to capture a single image to identify the weld seam and plan the welding trajectory, which is of great significance and value for improving the production efficiency of thin-walled cylindrical cover plate welding and enhancing the welding quality.

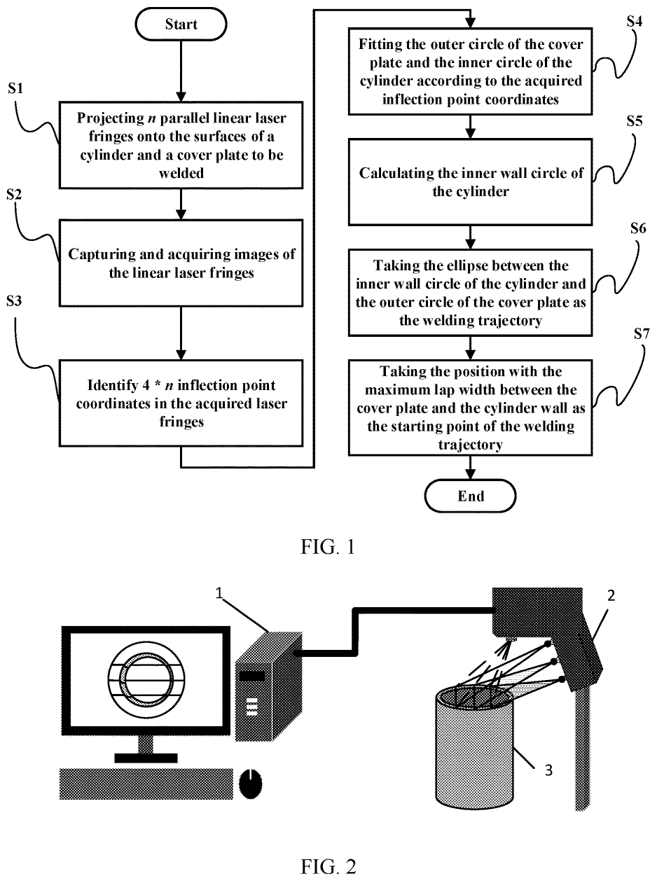

As shown in FIG. 1, the multi-beam laser-based weld seam recognition and welding path planning method oriented to the welding and packaging of a cylinder and a cover plate according to the present invention includes the following steps:

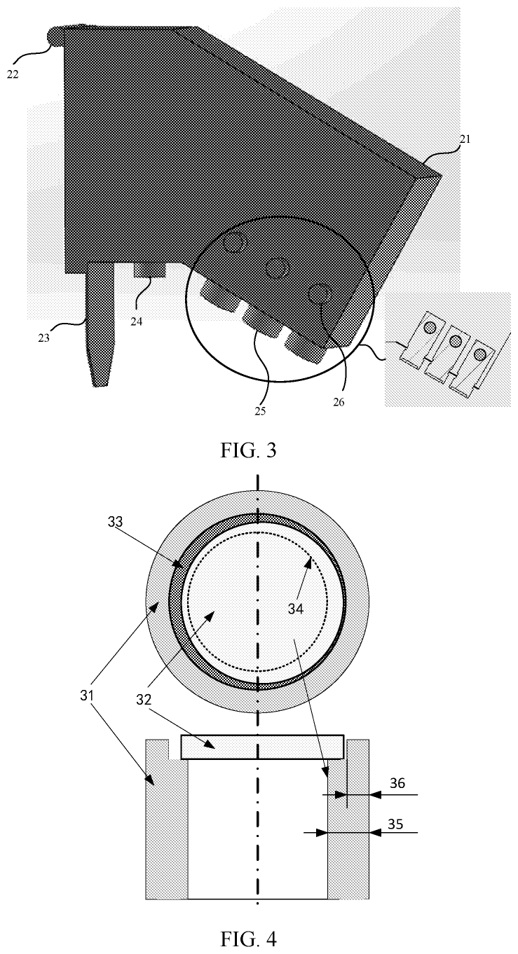

S1. Project n (where n≥2) parallel linear laser fringes onto the surfaces of the cylinder and the cover plate to be welded simultaneously. A typical scenario is shown in FIG. 2: a host computer 1 is connected to a linear laser sensor 2 which projects parallel linear laser fringes onto the surfaces of the cylinder to be welded and the cover plate 3; and the structure of the linear laser sensor is shown in FIG. 3: 21 is the sensor casing; 22 is the fixture, allowing the sensor to be installed on the workbench; 23 is the shading plate, preventing ambient light from the opposite side from interfering with the sensor; 24 is the industrial camera, which is connected to the host computer via Gigabit Ethernet and controlled through the accompanying software; 25 are three line laser generators, emitting three parallel linear laser fringes; 26 is the adjustment knob, which can adjust the angle of the laser, so that the three parallel line laser fringes can cover the upper surface of the cylinder and the cover plate to be welded, and during use, the sensor is fixed on the industrial robotic arm or a specific bracket through 22, allowing the industrial camera 24 to face the upper surface of the cylinder and the cover plate to be welded; by adjusting the knob 26, the line laser 25 is adjusted so that the emitted linear laser fringes cover the upper surface of the cylinder and the cover plate to be welded; adjust the position of the sensor so that the industrial camera 24 can clearly capture the upper surface of the cylinder and the cover plate to be welded and the three parallel line laser fringes, and finally execute the shooting; the structure of the cylinder and the cover plate to be welded is shown in FIG. 4:31 is the outer cylinder and is the cover plate, 33 is a gap between the cover plate and the outer cylinder, the inner wall 34 of the cylinder is covered by the cover plate 32, the thickness of the cylinder wall is denoted as 35, and the thickness of the cylinder boss is 36.

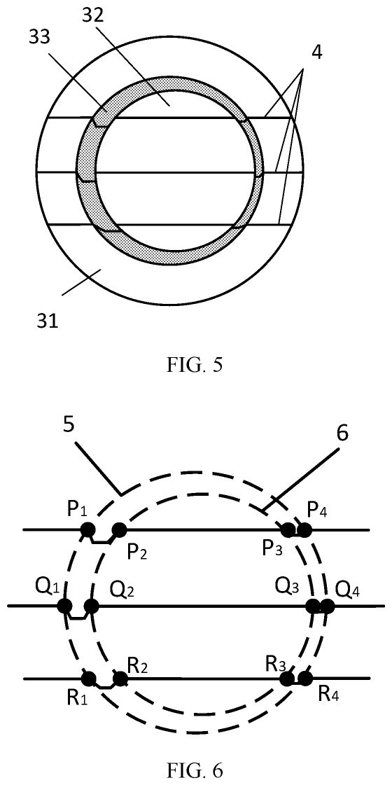

S2. As shown in FIG. 2, industrial camera 24 loaded on the multi-beam laser sensor and arranged at a preset angle relative to the laser projection direction captures and acquires images of the linear laser fringes, an example of the acquired images is shown in FIG. 5, which presents three parallel linear laser fringes 4; the angle between the camera and the incident direction of the linear laser is determined according to actual conditions, with the criterion of being able to capture clear linear laser fringes; in this embodiment, the angle is set to 30°; a host computer 1 processes the acquired image data, extracts the coordinates of high-brightness pixels in the images, and reconstructs the geometric features of the laser fringes according to the principle of triangulation.

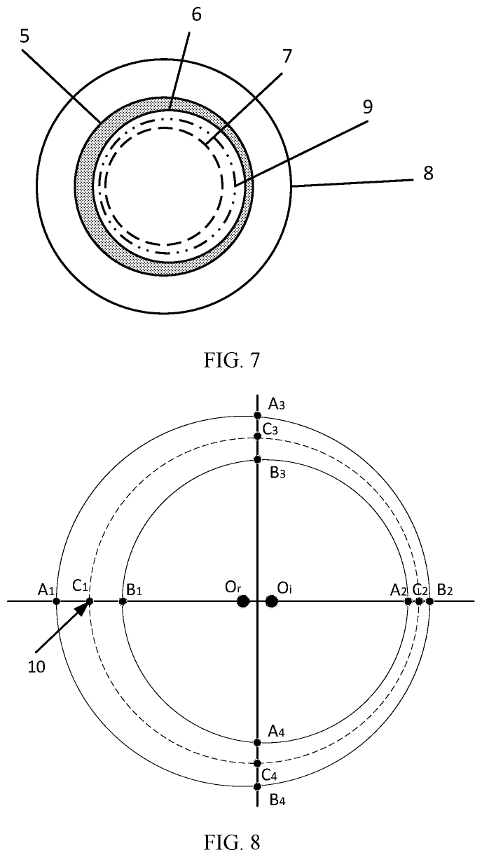

S3. Identify the coordinates of the inflection points of the laser fringes in the acquired images: the relationship between the number of inflection points (denoted as m) and the number of fringes (denoted as n) is m=4n, and the inflection points include outer inflection points and inner inflection points: the outer inflection points are the intersection points of the linear laser fringes with the adjacent surfaces of the boss of the cylinder and the gap between the cylinder and the cover plate, and the inner inflection points are the intersection points of the linear laser fringes with the adjacent surfaces of the cover plate and the gap; as shown in FIG. 6, when three fringes are projected onto the surface of the cover plate, 12 inflection points are generated, and a total of 12 points in the image, namely P₁, P₂, P₃, P₄, Q₁, Q₂, Q₃, Q₄, R₁, R₂, R₃ and R₄, are identified; the geometric features of the end of the cylinder and the plate to be welded are shown in FIG. 7, which are composed of an inner circle 5 of the outer cylinder, an outer circle 6 of the cover plate, an inner wall circle 7 of the cylinder, and an outer circle 8 of the outer cylinder; reference numeral 9 denotes the welding trajectory.

S4. Fit the equation of the inner circle 5 of the outer cylinder according to the outer inflection points, and fit the equation of the outer circle 6 of the cover plate according to the inner inflection points; as shown in FIG. 5 for specific implementation, the equation of the inner circle 5 of the outer cylinder is fitted based on points P₁, P₄, Q₁, Q₄, R₁ and R₄:

$${( {x}_{1} - {x}_{o} )}^{2} + {( {y}_{1} - {y}_{o} )}^{2} = {R}_{o}^{2}$$

where xₒ and yₒ are the coordinates of the center of the inner circle of the outer cylinder, Rₒ is the radius of the inner circle of the outer cylinder, and x₁ and y₁ are the horizontal and vertical coordinates of points on the inner circle of the outer cylinder; the equation of the outer circle 6 of the cover plate is fitted based on points P₂, P₃, Q₂, Q₃, R₂ and R₃:

$${( {x}_{2} - {x}_{r} )}^{2} + {( {y}_{2} - {y}_{r} )}^{2} = {R}_{r}^{2}$$

where xᵣ and yᵣ are the coordinates of the center of the outer circle of the cover plate, Rᵣ is the radius of the outer circle of the cover plate, and x₂ and y₂ are the horizontal and vertical coordinates of points on the outer circle of the cover plate.

S5. Calculate the equation of the inner wall circle 7 of the cylinder:

(x₃−x₀)²+(y₃−y₀)²=(Rₒ−t)²
where x₃ and y₃ are the horizontal and vertical coordinates of points on the inner wall circle of the cylinder, as shown in FIG. 7, t is obtained by subtracting the thickness of the cylindrical boss 36 from the thickness of the cylinder wall 35.

S6. Calculate the welding trajectory 9, as shown in FIG. 8: when the cover plate and the cylinder are not coaxial, the welding trajectory 9 shall be an ellipse, therefore the welding trajectory 9 is calculated in the following manner: first, connect the center Oᵢ of the inner wall circle of the cylinder and the center Oᵣ of the outer circle of the cover plate, and calculate 4 intersection points A₁, B₁, A₂ and B₂ of the straight line where OᵢOᵣ lies with the two circles; take the midpoint C₁ of A₁ and B₁ and the midpoint C₂ of A₂ and B₂ as the endpoints of the major axis of the ellipse; draw a perpendicular line to OᵢOᵣ through the midpoint of the two circle centers, which intersects the two circles at points A₃, B₃, A₄, B₄. Take the midpoint C₃ of A₃ and B₃ and the midpoint C₄ of A₄ and B₄ as the endpoints of the minor axis of the ellipse, then calculate the ellipse based on C₁, C₂, C₃, and C₄.

S7. If |A₁B₁|>|A₂B₂|, the start and end point 10 of the welding trajectory is C₁; otherwise, it is C₂.

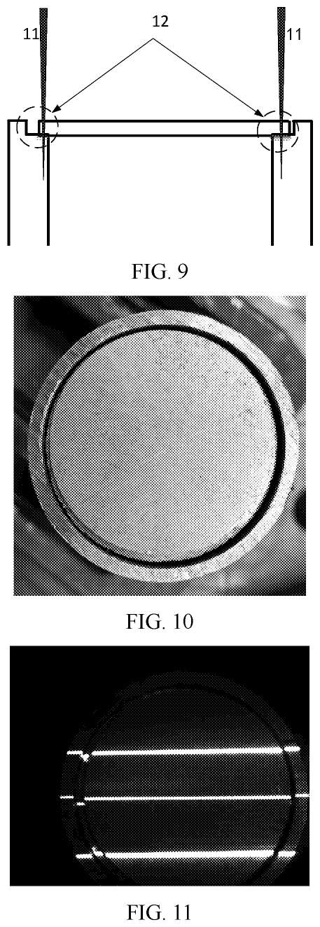

As shown in FIG. 9, the multi-beam laser-based weld seam recognition and welding path planning method provided in this embodiment is laser welding, where a laser 11 penetrates the cover plate and fuses with the cylinder wall; since the inner wall of the cylinder at position 12 and the lap joint between the cylinder wall and the cover plate are blocked by the cover plate, it is impossible to directly observe the lap joint and plan the welding trajectory. Therefore, it is necessary to obtain the contour of the inner circle of the outer cylinder; the inner wall circle of the cylinder is concentric with the inner circle of the outer cylinder, and the difference between the radius of the two circles is equal to the difference between the wall thickness of the cylinder and the wall thickness of the region to be welded. Based on this, the equation of the inner wall circle of the cylinder is derived. After obtaining the equation of the outer circle of the cover plate, the ellipse located inside the outer circle of the cover plate and in the middle of the area outside the inner wall circle of the cylinder is taken as the welding trajectory, which can ensure that the weld seam is always located at the center of the overlapping region between the cover plate and the cylinder wall. The start point and end point of the elliptical welding trajectory are at the same position, which are repeatedly heated during the welding process, resulting in a relatively large thermal influence caused by welding. If the start point is set at a position where the overlapping part between the cover plate and the cylinder wall is narrow, it will be more likely to cause severe thermal deformation and affect the welding quality. Therefore, the position where the overlapping part between the cover plate and the cylinder wall is the widest is selected as the start point and end point of the welding.

Next, considering a specific implementation case of the method proposed by this invention: consider the task of welding a cylinder and a cover plate, the outer diameter of the cylinder is 60 mm, the inner diameter is 43 mm, the total wall thickness is 8.5 mm, the wall thickness at the welding site is 3.5 mm, the thickness of the cover plate is 3 mm, as shown in FIG. 10.

Projecting three parallel linear laser fringes onto both the cylinder and the cover plate to be welded simultaneously, capture an image of the linear laser fringes, as shown in FIG. 11, identify the coordinates of the 12 intersection points of all the linear laser fringes in the obtained image, which are as follows: (949.4195, −1150.0106), (1030.7275, −1144.8231), (953.2111, −1110.5412), (1030.7349, −1105.4280), (949.4903, −1065.4341), (1030.7983, −1060.2466), (951.4705, −1149.2071), (1026.1545, −1144.2687), (957.2771, −1109.7560), (1023.6193, −1105.4357), (951.5413, −1064.6306), (1026.2253, −1059.6922).

Fitting the inner circle of the outer cylinder Cₒ by the intersection points:

(x₁−990.3490)²+(y₁+1104.5939)²=26.49²
fitting the outer circle of the plate Cᵣ by the intersection points:

(x₂−988.9147)²+(y₂+1103.8235)²=25.00²
calculating the inner circle of the cylinder Cᵢ:

(x₃−990.3490)²+(y₃+1104.5939)²=21.49²
connecting the center Oᵢ of the inner wall circle of the cylinder and the center Oᵣ of the outer circle of the cover plate, fitting the straight line that passes Oᵢ and Oᵣ:

0.770400x+1.434300y+821.354161=0
calculating the intersections of straight line OᵢOᵣ and outer circle of the cover plate: A₁(1010.9387, −1115.6532), A₂(966.8907, −1091.9938); calculate the intersections of straight line OᵢOᵣ and inner wall circle of the cylinder: B₁(1009.2808, −1114.7627), B₂(971.4171, −1094.4251); calculate the intersection points of the outer circle of the cover plate and the straight line that passes the center point of OᵢOᵣ and is perpendicular to OᵢOᵣ: A₃(977.8084, −1126.2211), A₄(1001.4553, −1082.1963); calculate the intersection points of the inner wall circle of the cylinder and the straight line that passes the center point of OᵢOᵣ and is perpendicular to OᵢOᵣ: B₃(979.4703, −1123.1270), B₄(999.7934, −1085.2904).

Calculating the center point of A₁B₁: C₁(1010.1098, −1115.2080), the center point of A₂B₂: C₂(969.1539, −1093.2095), the center point of A₃B₃: C₃(978.6394, −1124.6741) and the center point of A₄B₄: C₄(1000.6244, −1083.7434); fitting the welding trajectory ellipse by C₁, C₂, C₃ and C₄:

0.001851x²+0.000002xy+0.001852y²−3.6620x+4.0892y+4068.6643=0

Since |A₁B₁|>|A₂B₂|, the start and end point of the welding trajectory is C₁.

The method proposed in the present invention takes into account the positional deviation caused by the non-coincidence of the central axes of the cylinder and the cover plate due to assembly, reduces the occurrence of welding defects, and is particularly suitable for the welding of cylindrical cover plates with high welding precision requirements or micro-miniature cylindrical cover plates. Compared with the prior art, the present invention does not need to use a linear laser to scan the workpiece to obtain the three-dimensional contour of the surface; instead, it directly identifies the central path of the weld seam from a single image, achieving high efficiency.

The above is a detailed description of the preferred specific embodiments of the present invention. It should be understood that those of ordinary skill in the art can make many modifications and variations based on the concept of the present invention without creative work. Therefore, all technical solutions that can be obtained by those skilled in the art in the technical field through logical analysis, reasoning or limited experiments on the basis of the prior art according to the concept of the present invention shall fall within the protection scope defined by the claims.

What is claimed is:

1. A multi-beam laser-based weld seam recognition and welding path planning method oriented to welding and packaging of a cylinder and a cover plate, comprising the following steps:
simultaneously projecting n parallel linear laser fringes onto surfaces of a cylinder and a cover plate to be welded, wherein n≥2, and shooting and acquiring images of all linear laser fringes;
identifying coordinates of inflection points of all the linear laser fringes in acquired images, and fitting an outer circle of the cover plate and an inner circle of an outer cylinder based on identified coordinates of the inflection points;
calculating an inner wall circle of the cylinder according to the inner circle of the outer cylinder and a wall thickness of the cylinder, and taking an ellipse between the inner wall circle of the cylinder and the outer circle of the cover plate as a welding trajectory; wherein a method for calculating the welding trajectory is as follows:
first, connecting a center O; of the inner wall circle of the cylinder and a center Oᵣ of the outer circle of the cover plate, calculating 4 intersection points of a straight line where OᵢOᵣ lies with the outer circle of the cover plate and the inner wall circle of the cylinder, and denoting the 4 intersection points in sequence as A₁, B₁, A₂ and B₂; taking a midpoint C₁ of A₁ and B₁ and a midpoint C₂ of A₂ and B₂ as endpoints of a major axis of the ellipse; drawing a perpendicular line to OᵢOᵣ through a midpoint between the centers Oᵢ and Oᵣ of two circles, with intersection points with the two circles denoted in sequence as A₃, B₃, A₄ and B₄; taking a midpoint C₃ of A₃ and B₃ and a midpoint C₄ of A₄ and B₄ as endpoints of a minor axis of the ellipse; and calculating the ellipse based on C₁, C₂, C₃, and C₄, that is, a central ellipse of a figure between the inner wall circle of the cylinder and the outer circle of the cover plate, which serves as the welding trajectory; and
taking a widest part of an overlapping region of the cover plate and a cylinder wall as start and end points of the welding trajectory.

2. The multi-beam laser-based weld seam recognition and welding path planning method oriented to the welding and packaging of the cylinder and the cover plate according to claim 1, wherein the parallel linear laser fringes are generated by a linear laser device; the images of the linear laser fringes are shot by a camera arranged at a preset angle relative to a laser projection direction; and geometric features of the linear laser fringes are reconstructed according to principle of triangulation.

3. The multi-beam laser-based weld seam recognition and welding path planning method oriented to the welding and packaging of the cylinder and the cover plate according to claim 1, wherein the inflection points comprise outer inflection points and inner inflection points; the outer inflection points are intersection points of the linear laser fringes with adjacent surfaces of a boss of the cylinder and a gap between the cylinder and the cover plate; the inner inflection points are intersection points of the linear laser fringes with adjacent surfaces of the cover plate and the gap; and a total number of inflection points is 4*n.

4. The multi-beam laser-based weld seam recognition and welding path planning method oriented to the welding and packaging of the cylinder and the cover plate according to claim 3, wherein an equation of the inner circle C₀ of the outer cylinder is fitted according to 2*n outer inflection points:
$${( {x}_{1} - {x}_{o} )}^{2} + {( {y}_{1} - {y}_{o} )}^{2} = {R}_{o}^{2}$$
wherein xₒ and yₒ are coordinates of the center of the inner circle of the outer cylinder, Rₒ is a radius of the inner circle of the outer cylinder, and x₁ and y₁ are horizontal and vertical coordinates of points on the inner circle of the outer cylinder.
an equation of the outer circle Cᵣ of the cover plate is fitted according to 2*n inner inflection points:
$${( {x}_{2} - {x}_{r} )}^{2} + {( {y}_{2} - {y}_{r} )}^{2} = {R}_{r}^{2}$$
wherein xᵣ and yᵣ are coordinates of the center of the outer circle of the cover plate, Rᵣ is a radius of the outer circle of the cover plate, and x₂ and y₂ are horizontal and vertical coordinates of points on the outer circle of the cover plate.

5. The multi-beam laser-based weld seam recognition and welding path planning method oriented to the welding and packaging of the cylinder and the cover plate according to claim 1, wherein an equation of the inner wall circle of the cylinder is described as:
(x₃−x₀)²+(y₃−y₀)²=(Rₒ−t)²
wherein xₒ and yₒ are coordinates of the center of the inner circle of the outer cylinder, x₃ and y₃ are horizontal and vertical coordinates of points on the inner wall circle of the cylinder, Rₒ is a radius of the inner circle of the outer cylinder, and t is obtained by subtracting a thickness of a cylindrical boss from a total wall thickness of the cylinder.

6. The multi-beam laser-based weld seam recognition and welding path planning method oriented to the welding and packaging of the cylinder and the cover plate according to claim 1, wherein if |A₁B₁|>|A₂B₂|, the start and end points of the welding trajectory are C₁, otherwise, they are C₂.

7. A multi-beam laser-based weld seam recognition and welding path planning system oriented to welding and packaging of cylindrical cover plates, comprising:
a laser fringe image acquisition unit, configured to simultaneously project n parallel linear laser fringes onto surfaces of a cylinder to be welded and a cover plate, wherein n≥2, and capture and acquire all images of linear laser fringes;
a fitting unit, configured to identify coordinates of inflection points of all the linear laser fringes in acquired images, and fit an outer circle of the cover plate and an inner circle of an outer cylinder according to identified coordinates of the inflection points;
a welding trajectory calculation unit, configured to calculate an inner wall circle of a cylinder based on the inner circle of the outer cylinder and a wall thickness of the cylinder, and take a central ellipse of a figure between the inner wall circle of the cylinder and the outer circle of the cover plate as a welding trajectory; specifically:
first, connecting a center Oᵢ of the inner wall circle of the cylinder and a center Oᵣ of the outer circle of the cover plate, calculating 4 intersection points of a straight line where OᵢOᵣ lies with the outer circle of the cover plate and the inner wall circle of the cylinder, sequentially denoting them as A₁, B₁, A₂ and B₂, and taking a midpoint C₁ of A₁ and B₁ and a midpoint C₂ of A₂ and B₂ as endpoints of a major axis of an ellipse; drawing a perpendicular line to OᵢOᵣ through a midpoint of the centers Oᵢ and Oᵣ of two circles, with intersection points with the two circles sequentially denoted as A₃, B₃, A₄ and B₄; taking a midpoint C₃ of A₃ and B₃ and a midpoint C₄ of A₄ and B₄ as endpoints of a minor axis of the ellipse; and calculating the ellipse based on C₁, C₂, C₃ and C₄, i.e., the central ellipse of the figure between the inner wall circle of the cylinder and the outer circle of the cover plate, which serves as the welding trajectory; and
a welding trajectory start and end point determination unit, configured to take a widest part of an overlapping region where the cover plate and a cylinder wall are lapped and coincided as start and end points of the welding trajectory.

8. An electronic device, comprising:
a memory storing executable program codes; and
a processor coupled to the memory;
wherein the processor invokes the executable program codes stored in the memory, and executes steps of a multi-beam laser-based weld seam recognition and welding path planning method oriented to welding and packaging of a cylinder and a cover plate.

9. A computer-readable storage medium, wherein the computer-readable storage medium stores computer instructions, and when the computer instructions are invoked, they are used to execute the steps of the multi-beam laser-based weld seam recognition and welding path planning method oriented to the welding and packaging of the cylinder and the cover plate according to claim 1.

10. The computer-readable storage medium according to claim 9, wherein in the multi-beam laser-based weld seam recognition and welding path planning method oriented to the welding and packaging of the cylinder and the cover plate, the parallel linear laser fringes are generated by a linear laser device; the images of the linear laser fringes are shot by a camera arranged at a preset angle relative to a laser projection direction; and geometric features of the linear laser fringes are reconstructed according to principle of triangulation.

11. The computer-readable storage medium according to claim 9, wherein in the multi-beam laser-based weld seam recognition and welding path planning method oriented to the welding and packaging of the cylinder and the cover plate, the inflection points comprise outer inflection points and inner inflection points; the outer inflection points are intersection points of the linear laser fringes with adjacent surfaces of a boss of the cylinder and a gap between the cylinder and the cover plate; the inner inflection points are intersection points of the linear laser fringes with adjacent surfaces of the cover plate and the gap; and a total number of inflection points is 4*n.

12. The computer-readable storage medium according to claim 11, wherein in the multi-beam laser-based weld seam recognition and welding path planning method oriented to the welding and packaging of the cylinder and the cover plate, an equation of the inner circle Cₒ of the outer cylinder is fitted according to 2*n outer inflection points:
$${( {x}_{1} - {x}_{o} )}^{2} + {( {y}_{1} - {y}_{o} )}^{2} = {R}_{o}^{2}$$
wherein xₒ and yₒ are coordinates of the center of the inner circle of the outer cylinder, Rₒ is a radius of the inner circle of the outer cylinder, and x₁ and y₁ are horizontal and vertical coordinates of points on the inner circle of the outer cylinder.
an equation of the outer circle Cᵣ of the cover plate is fitted according to 2*n inner inflection points:
$${( {x}_{2} - {x}_{r} )}^{2} + {( {y}_{2} - {y}_{r} )}^{2} = {R}_{r}^{2}$$
wherein xᵣ and yᵣ are coordinates of the center of the outer circle of the cover plate, Rᵣ is a radius of the outer circle of the cover plate, and x₂ and y₂ are horizontal and vertical coordinates of points on the outer circle of the cover plate.

13. The computer-readable storage medium according to claim 9, wherein in the multi-beam laser-based weld seam recognition and welding path planning method oriented to the welding and packaging of the cylinder and the cover plate, an equation of the inner wall circle of the cylinder is described as:
(x₃−x₀)²+(y₃−y₀)²=(Rₒ−t)²
wherein xₒ and yₒ are coordinates of the center of the inner circle of the outer cylinder, x₃ and y₃ are horizontal and vertical coordinates of points on the inner wall circle of the cylinder, Rₒ is a radius of the inner circle of the outer cylinder, and t is obtained by subtracting a thickness of a cylindrical boss from a total wall thickness of the cylinder.

14. The computer-readable storage medium according to claim 9, wherein in the multi-beam laser-based weld seam recognition and welding path planning method oriented to the welding and packaging of the cylinder and the cover plate, if |A₁B₁|>|A₂B₂|, the start and end points of the welding trajectory are C₁, otherwise, they are C₂.
